(19) United States
(12) Patent Application Publication
(10) Pub. No.: US 2015/0302675 A1
(43) Pub. Date: Oct. 22, 2015

(54) Vision System to Authenticate Documents

(71) Applicants: Vitaly Talyansky, Portland, OR (US); Edward Talyansky, Battle Ground, WA (US); Jose Gasque, Vancouver, WA (US)

(72) Inventors: Vitaly Talyansky, Portland, OR (US); Edward Talyansky, Battle Ground, WA (US); Jose Gasque, Vancouver, WA (US)

(21) Appl. No.: 14/256,789

(22) Filed: Apr. 18, 2014

(51) Int. Cl. G07D 7/00

(52) U.S. Cl. CPC G07D 7/0046

(57) ABSTRACT

A vision system to authenticate documents is described herein. An example apparatus includes an illuminating source to illuminate a pattern on a sample with first infrared light having a peak wavelength at a first wavelength, wherein the pattern is printed with ink that has luminescent properties such that when the pattern is illuminated by infrared light containing the first wavelength, the pattern emits second infrared light having a peak wavelength at a second wavelength, a filter adjacent to the illuminating source, wherein the filter passes the second infrared light and the filter does not pass the first infrared light, a photo element in close proximity to the filter such that the second infrared light that passes through the filter illuminates the photo element, wherein the photo element detects the second infrared light and captures an image of the pattern, and a display to display the image captured by the photo element.

### FIELD OF THE DISCLOSURE

The present disclosure relates generally to document and/or product authentication and, more particularly, to a vision system to authenticate documents.

### BACKGROUND

Documents and/or product packaging can be printed with marked ink. These documents and/or product packaging can later be authenticated by detecting the marked ink.

### BRIEF DESCRIPTION OF THE DRAWINGS

FIG. 1 is a block diagram of a vision system to authenticate documents in accordance with the teachings of this disclosure.

FIG. 2 is a flowchart representative of example machine readable instructions that may be executed to implement the example vision system of FIG. 1.

FIG. 3 is a block diagram of an example processing system capable of executing the example machine readable instructions of FIG. 2 to implement the example vision system of FIG. 1.

### DETAILED DESCRIPTION

Counterfeit products can cause significant economic and other damage to both the purveyor of authentic non-counterfeit products and the consumer of the counterfeit products. Counterfeit documents can likewise cause economic and/or other damage. One method to prevent counterfeiting of products and/or documents is to print a document or to print the packaging and/or labeling for a product or to print a marking on a product using special ink that can later be authenticated. Counterfeit products will not have this special ink and therefore cannot be authenticated.

One type of special ink that can be used for authentication is ink that contains sub-micron particles that have luminescent properties, such as the system described in co-pending patent application Ser. No. 14/177,642 entitled “Variable Data Printing For Security Purposes Using Ceramic Sub-Micron Infrared-Luminescent Particles In Inkjet Ink,” which is herein incorporated by reference. When this type of ink is printed onto a document or product packaging, the sub-micron particles are transferred to the document or product packaging. The document or product packaging can then be authenticated by illuminating the printed ink on the document or product packaging with electromagnetic radiation at a wavelength that causes the sub-micron particles to luminesce and then detecting that luminescence. Documents and/or products that are not authentic will not have the sub-micron particles and thus will not luminesce.

Example methods, apparatus, and/or articles of manufacture disclosed herein provide a vision system to authenticate documents and/or products. In examples disclosed herein, the documents and/or product packaging to be authenticated have markings printed on them using an ink that has luminescent properties. In examples disclosed herein, the markings on the documents and/or product packaging emit a luminescent response when illuminated with infrared light of a particular wavelength.

In examples disclosed herein, the vision system includes an imager with an illuminating source that emits infrared light with a wavelength that causes a luminescent response by the markings on a document or product packaging to be authenticated. In examples disclosed herein, the imager includes a photo element (e.g., an infrared camera) to detect the luminescent emission from the markings on the document or product packaging to be authenticated. In examples disclosed herein, imager contains a filter in front of the photo element that blocks the infrared emission from the illuminating source but passes the luminescent emission from the markings on the document or product packaging. In examples disclosed herein, the imager includes a display to display the detected markings to a user.

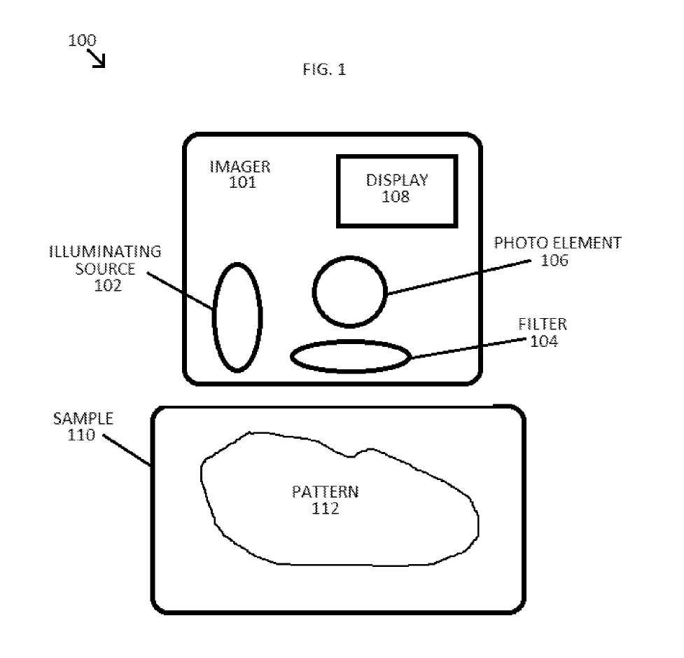

FIG. 1 is a block diagram of a vision system 100 to authenticate documents in accordance with the teachings of this disclosure. The example vision system 100 of FIG. 1 includes an imager 101 and a sample 110. The example imager 101 includes an illuminating source 102, a filter 104, a photo element 106, and a display 108. The example sample 110 includes a pattern 112.

The example illuminating source 102 of FIG. 1 illuminates the example pattern 112 with infrared light having a wavelength that causes the pattern 112 to luminesce. In the illustrated example, the illuminating source 102 is a laser. In other examples, the illuminating source 102 may be an LED or any other source capable of emitting infrared light at the appropriate wavelength to cause a luminescent response by the pattern 112.

The example filter 104 of FIG. 1 is an optical filter that passes the luminescence emitted by the example pattern 112 but blocks the emission from the example illuminating source 102. When the example pattern 112 is illuminated with infrared light having a particular wavelength, the pattern 112 luminesces and emits infrared light having a different wavelength. The difference between the wavelength that causes the luminescence in the example pattern 112 and the wavelength emitted by the example pattern 112 is known as the Stokes shift. After the example illuminating source 102 in the example imager 101 emits infrared light to trigger luminescence by the example pattern 112, the luminescent emission of the pattern 112 illuminates the front of the imager 101. However, the reflection or other propagation of the illuminating source 102 may also illuminate the imager 101. Therefore, the example filter 104 is needed to filter out the light from the example illuminating source 102 so that the example photo element 106 will only detect the luminescent emission from the example pattern 112 and not the emission from the illuminating source 102. In the illustrated example, the luminescent emission of the pattern 112 has a higher wavelength than the emission of the illuminating source 102. Therefore, in the illustrated example, the filter 104 is a high-pass filter (i.e., the filter 104 only passes light with a wavelength above a certain wavelength). In other examples, the luminescent emission of the pattern 112 may have a lower wavelength than the emission of the illuminating source 102. In these examples, the filter 104 is a low-pass filter (i.e., the filter 104 only passes light with a wavelength below a certain wavelength). In other examples, a band-pass filter allowing only certain wavelengths through the filter 104 are used.

The example photo element 106 detects the luminescent emission from the example pattern 112 after it passes through the example filter 104 and any emission from the example illuminating source 102 is filtered out. The example photo element 106 detects the two-dimensional pattern of the luminescent emission from the example pattern 112 and sends the detected two-dimensional image to the example display 108. In the illustrated example, the photo element 106 is a charge-coupled device (CCD) camera that detects infrared light. In other examples, the photo element 106 may be any device capable of detecting the two-dimensional luminescent emission of the pattern 112.

The example display 108 displays the image output by the example photo element 106. Because the example photo element 106 detects and outputs the luminescent emission of the pattern 112, the example display 108 displays an image of the pattern 112. In the illustrated example, the display 108 is a screen visible to a user of the imager 100.

The example sample 110 is a document or product to be authenticated. The example pattern 112 is a marking printed on the example sample 110. In the illustrated example, the pattern 112 is a barcode. In other examples, the pattern 112 may be text, an image or any other visual pattern. The example pattern 112 may be printed on a document or product packaging or may be printed directly on a product. The example pattern 112 is printed with ink that has luminescent properties such that when the pattern 112 is illuminated with an infrared illuminating light source having a particular wavelength, it emits infrared light having a peak wavelength different from the wavelength of the infrared illuminating light source. In the illustrated example, the pattern 112 is printed with ink containing ceramic particles that have infrared luminescent properties. In other examples, the pattern 112 may be printed with any other type of ink such that the pattern 112 has the appropriate luminescent properties.

If the example sample 110 is authentic (i.e., not counterfeit), the example pattern 112 on the sample 110 will be displayed in the example display 108. If the example sample 110 is not authentic, the example pattern 112 on the sample 110 will not luminesce when illuminated by the example illuminating source 102 and the pattern 112 will not be displayed in the example display 108. In some examples, the pattern 112 is printed in the same color as the sample 110 (e.g., the pattern 112 is printed with white ink on white paper) and the pattern 112 is invisible to the naked eye. In these examples, the pattern 112 can only be seen through the display 108 after illuminating the pattern 112 with the illuminating source 102. In other examples, the pattern 112 is visible to the naked eye on the sample 110 and the pattern shows up in a different color in the display 108 after the pattern 112 is illuminated by the illuminating source 102 than it does on the sample 110.

While an example manner of implementing the vision system to authenticate documents has been illustrated in FIG. 1, one or more of the elements, processes and/or devices illustrated in FIG. 1 may be combined, divided, re-arranged, omitted, eliminated and/or implemented in any other way. Further, the example imager 101, the example illuminating source 102, the example filter 104, the example photo element 106, the example display 108 and/or, more generally, the example vision system to authenticate documents 100 of FIG. 1 may be implemented by hardware, software, firmware and/or any combination of hardware, software and/or firmware. Thus, for example, any of the example imager 101, the example illuminating source 102, the example filter 104, the example photo element 106, the example display 108 and/or, more generally, the example vision system to authenticate documents 100 of FIG. 1 could be implemented by one or more circuit(s), programmable processor(s), application specific integrated circuit(s) (ASIC(s)), programmable logic device(s) (PLD(s)), microprocessor(s), hardware processor(s), and/or field programmable logic device(s) (FPLD(s)), etc. When any of the system or apparatus claims of this patent are read to cover a purely software and/or firmware implementation, at least one of the example imager 101, the example illuminating source 102, the example filter 104, the example photo element 106, the example display 108 and/or, more generally, the example vision system 100 to authenticate documents of FIG. 1 is hereby expressly defined to include a tangible computer readable storage medium such as a memory, DVD, CD, Blu-ray, etc. storing the software and/or firmware. Further still, the example imager 101, the example illuminating source 102, the example filter 104, the example photo element 106, the example display 108 and/or, more generally, the example vision system 100 to authenticate documents of FIG. 1 may include more than one of any or all of the illustrated elements, processes and devices.

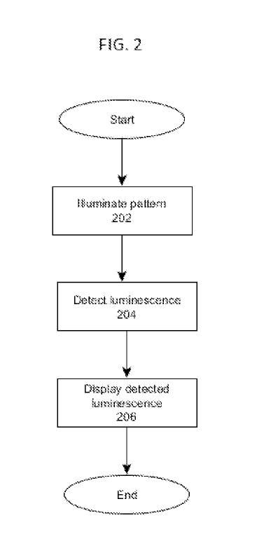

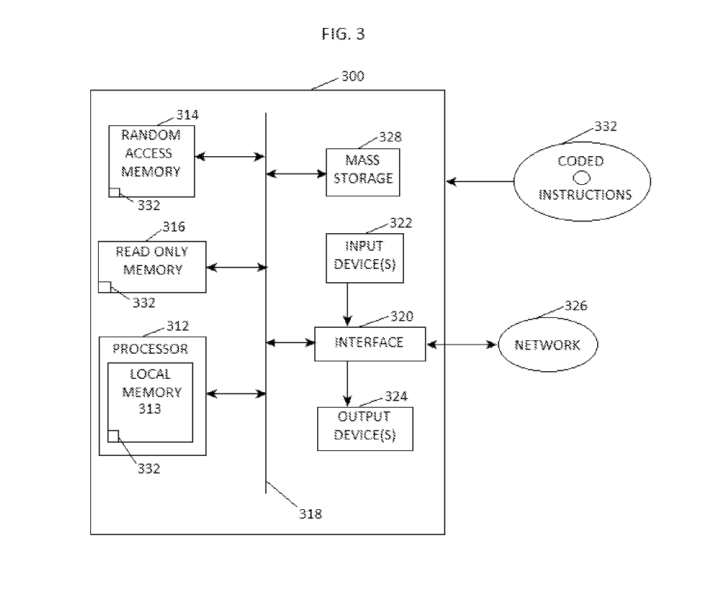

FIG. 2 is a flowcharts representative of example machine readable instructions for implementing the example vision system to authenticate documents 100 of FIG. 1. In the example flowchart of FIG. 2, the machine readable instructions comprise program(s) for execution by a processor such as the processor 312 shown in the example computer 300 discussed below in connection with FIG. 3. The program(s) may be embodied in software stored on a tangible computer readable storage medium such as a CD-ROM, a floppy disk, a flash drive, a hard drive, a digital versatile disk (DVD), a Blu-ray disk, or a memory associated with the processor 312, but the entire program and/or parts thereof could alternatively be executed by a device other than the processor 312 and/or embodied in firmware or dedicated hardware. Further, although the example program(s) is described with reference to the flowchart illustrated in FIG. 2, many other methods of implementing the example vision system to authenticate documents 100 of FIG. 1 may alternatively be used. For example, the order of execution of the blocks may be changed, and/or some of the blocks described may be changed, eliminated, or combined.

As mentioned above, the example processes of FIG. 2 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage device and/or disk and to exclude propagating signals. Additionally or alternatively, the example processes of FIG. 2 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable storage medium is expressly defined to include any type of computer readable storage device and/or disk and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 2 begins when the example illuminating source 102 in the example imager 100 illuminates the example pattern 112 on the example sample 110 with infrared light having a wavelength to cause a luminescent response by the pattern 112 (block 202). In the illustrated example, the illuminating source 102 continuously emits the infrared light while the imager 100 is in operation. In some examples, the illuminating source 102 may emit the infrared light for a certain duration of time. In some examples, the illuminating source 102 may emit the infrared light in short pulses. In some examples, a user of the imager 100 can turn the illuminating source 102 off and on using a switch or other means on the imager 100.

When the example illuminating source 102 illuminates the example pattern 112 with the appropriate wavelength of infrared light (block 202), the pattern 112 luminesces and emits infrared light having a peak wavelength different from the wavelength of the infrared light emitted by the illuminating source 102. This luminescent emission from the example pattern 112 passes through the example filter 104 and is detected by the example photo element 106 (block 204). The example photo element 106 detects the two-dimensional image emitted by the example pattern 112.

After the example photo element 106 detects the luminescent emission from the example pattern 112 (block 204), the example display 108 displays the two-dimensional image detected by the photo element 106 (block 206). The example of FIG. 2 then ends.

FIG. 3 is a block diagram of a processor platform 300 capable of executing the instructions of FIG. 2 to implement the example vision system to authenticate documents 100 of FIG. 1. The processor platform 300 can be, for example, a server, a personal computer, an Internet appliance, a DVD player, a CD player, a Blu-ray player, a gaming console, a personal video recorder, a smart phone, a tablet, a printer, or any other type of computing device.

The processor platform 300 of the instant example includes a processor 312. As used herein, the term “processor” refers to a logic circuit capable of executing machine readable instructions. For example, the processor 312 can be implemented by one or more microprocessors or controllers from any desired family or manufacturer.

The processor 312 includes a local memory 313 (e.g., a cache) and is in communication with a main memory including a volatile memory 314 and a non-volatile memory 316 via a bus 318. The volatile memory 314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 316 may be implemented by flash memory and/or any other desired type of memory device. Access to the main memory 314, 316 is controlled by a memory controller.

The processor platform 300 also includes an interface circuit 320. The interface circuit 320 may be implemented by any type of interface standard, such as an Ethernet interface, a universal serial bus (USB), and/or a PCI express interface.

One or more input devices 322 are connected to the interface circuit 320. The input device(s) 322 permit a user to enter data and commands into the processor 312. The input device(s) can be implemented by, for example, a keyboard, a mouse, a touchscreen, a track-pad, a trackball, isopoint and/or a voice recognition system.

One or more output devices 324 are also connected to the interface circuit 320. The output devices 324 can be implemented, for example, by display devices (e.g., a liquid crystal display, a cathode ray tube display (CRT), a printer and/or speakers). The interface circuit 320, thus, typically includes a graphics driver card.

The interface circuit 320 also includes a communication device such as a modem or network interface card to facilitate exchange of data with external computers via a network 326 (e.g., an Ethernet connection, a digital subscriber line (DSL), a telephone line, coaxial cable, a cellular telephone system, etc.).

The processor platform 300 also includes one or more mass storage devices 328 for storing software and data. Examples of such mass storage devices 328 include floppy disk drives, hard drive disks, compact disk drives and digital versatile disk (DVD) drives.

The coded instructions 332 of FIG. 3 may be stored in the mass storage device 328, in the volatile memory 314, in the non-volatile memory 316, and/or on a removable storage medium such as a CD or DVD.

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. An apparatus comprising:
an illuminating source to illuminate a pattern on a sample with first infrared light having a peak wavelength at a first wavelength, wherein the pattern is printed with ink that has luminescent properties such that when the pattern is illuminated by infrared light containing the first wavelength, the pattern emits second infrared light having a peak wavelength at a second wavelength;
a filter adjacent to the illuminating source, wherein the filter passes the second infrared light and the filter does not pass the first infrared light;
a photo element in close proximity to the filter such that the second infrared light that passes through the filter illuminates the photo element, wherein the photo element detects the second infrared light and captures an image of the pattern; and
a display to display the image captured by the photo element.

2. The apparatus of claim 1, wherein the sample is a document.

3. The apparatus of claim 1, wherein the sample is a product packaging.

4. The apparatus of claim 1, wherein the pattern is printed with ink containing ceramic particles less than one micron in size, the particles having luminescent properties such that they emit the second infrared light when illuminated by the first infrared light.

5. The apparatus of claim 1, wherein the filter passes light with wavelengths greater than a third wavelength, the third wavelength is greater than or equal to the first wavelength.

6. The apparatus of claim 1, wherein the pattern is printed in the same color as the sample and the pattern is invisible to the naked eye.

7. The apparatus of claim 1, wherein the pattern is a bar code.

8. A method comprising:
illuminating a pattern on a sample with first infrared light having a peak wavelength at a first wavelength, wherein the pattern is printed with ink that has luminescent properties such that when the pattern is illuminated by infrared light containing the first wavelength, the pattern emits second infrared light having a peak wavelength at a second wavelength;
filtering infrared light emitted by the pattern by passing light having the second wavelength and not passing light having the first wavelength;
detecting a first image of the infrared light emitted by the pattern; and
displaying the first image.

9. The method of claim 8, wherein the sample is a document.

10. The method of claim 8, wherein the sample is a product packaging.

11. The method of claim 8, wherein the pattern is printed with ink containing ceramic particles less than one micron in size, the particles having luminescent properties such that they emit the second infrared light when illuminated by the first infrared light.

12. The method of claim 8, wherein filtering light emitted by the pattern comprises passing light with wavelengths greater than a third wavelength, the third wavelength is greater than or equal to the first wavelength.

13. The method of claim 8, wherein the pattern is printed in the same color as the sample such that the pattern is invisible to the naked eye.

14. The method of claim 8, wherein the pattern is a bar code.

15. A tangible machine readable storage medium comprising instructions that, when executed, cause a machine to at least:
illuminate a pattern on a sample with first infrared light having a peak wavelength at a first wavelength, wherein the pattern is printed with ink that has luminescent properties such that when the pattern is illuminated by infrared light containing the first wavelength, the pattern emits second infrared light having a peak wavelength at a second wavelength;
filter infrared light emitted by the pattern by passing light having the second wavelength and not passing light having the first wavelength;
detect a first image of the infrared light emitted by the pattern; and
display the first image.

16. The storage medium of claim 15, wherein the sample is a document.

17. The storage medium of claim 15, wherein the sample is a product packaging.

18. The storage medium of claim 15, wherein the pattern is printed with ink containing ceramic particles less than one micron in size, the particles having luminescent properties such that they emit the second infrared light when illuminated by the first infrared light.

19. The storage medium of claim 15, wherein the pattern is a bar code.

20. The storage medium of claim 15, wherein the pattern is printed in the same color as the sample and the pattern is invisible to the naked eye.
